(19) United States
(12) Patent Application Publication
(10) Pub. No.: US 2011/0037573 A1
(43) Pub. Date: Feb. 17, 2011

(54) APPARATUS AND METHOD FOR PROVIDING INFORMATION OF GOODS IN MOBILE TERMINAL

(75) Inventor: Min-Sheok CHOI, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/842,358

(22) Filed: Jul. 23, 2010

(30) Foreign Application Priority Data
Aug. 11, 2009 (KR) 10-2009-0073623

(51) Int. Cl. H04Q 5/22

(52) U.S. Cl. 340/10.42

(57) ABSTRACT

An apparatus and a method for providing a goods information service in a mobile terminal are provided. The apparatus includes a goods information storage, a position determiner, and a controller. The goods information storage receives and stores tag information collected by an RFID reader. The position determiner determines position information of relevant goods using tag information corresponding to goods information among tag information already stored. When receiving a position information request, the controller processes to determine goods information included in the request and determine the position information of the relevant goods.

### PRIORITY

This application claims the benefit under 35 U.S.C. §119(a) of a Korean patent application filed in the Korean Intellectual Property Office on Aug. 11, 2009 and assigned Serial No. 10-2009-0073623, the entire disclosure of which is hereby incorporated by reference.

### BACKGROUND OF THE INVENTION

1. Field of the Invention

The present invention relates to an apparatus and a method for providing a goods information service in a mobile terminal. More particularly, the present invention relates to an apparatus and a method for determining a position of goods a user of a mobile terminal desires to seek using information of goods recorded on a Radio Frequency IDentification (RFID) tag.

2. Description of the Related Art

Distribution for mobile terminals has rapidly increased since the mobile terminals provide convenience in portability. Therefore, service providers (i.e., terminal manufacturers) have competitively developed a terminal having more convenient functions in order to attract many users.

For example, the mobile terminals provide functions such as a phonebook, games, a scheduler, a Short Message Service (SMS), a Multimedia Message Service (MMS), a broadcast message service, an Internet service, an Electronic (E)-mail, a morning call, a Motion Picture Expert Group Audio Layer-3 (MP3) player, a digital camera, and the like.

Users of the mobile terminals require an additional service function that is helpful to real life besides the above-described general functions. That is, the users of the mobile terminals require an additional service function that is helpful to everyday life such as a goods-purchase activity and a consuming activity.

For example, in a case where a user purchases goods in a major retail outlet, the user of the mobile terminal may recognize goods information, price information, and distribution information using the mobile terminal.

The user of the mobile terminal recognizes information of relevant goods using the mobile terminal, and then has to go to a position of the goods to be purchased in person in order to purchase the relevant goods.

However, since a place such as a major retail outlet is a large space, the user of the mobile terminal has to consume a lot of time in order to search for the relevant goods. Although the user moves in search of the position where the relevant goods are displayed, when the relevant goods are sold out, the user consumes more time in purchasing goods.

The above-described problem cannot properly provide the additional service function that is helpful to an everyday life such as the user's goods-purchase activity and consumption activity.

Therefore, a need exists for an apparatus and a method for reducing time consumed for purchasing goods by allowing a user to conveniently recognize a position of relevant goods.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for aiding to a user's purchase activity by providing a goods information service in a mobile terminal.

Another aspect of the present invention is to provide an apparatus and a method for providing a goods information service that provides position information of relevant goods in a mobile terminal.

Still another aspect of the present invention is to provide an apparatus and a method for recognizing position information of goods using tag information recorded on a Radio Frequency IDentification (RFID) tag and information of an RFID reader that recognizes the tag information in a mobile terminal.

In accordance with an aspect of the present invention, an apparatus for providing goods information at an information collector is provided. The apparatus includes a goods information storage for receiving and storing tag information collected by an RFID reader, a position determiner for determining position information of relevant goods using tag information corresponding to goods information among tag information already stored, and a controller for, when receiving a position information request, processing to determine goods information included in the request and determine the position information of the relevant goods.

In accordance with another aspect of the present invention, a method for providing goods information at an information collector is provided. The method includes receiving and storing tag information collected by an RFID reader, when receiving a position information request, determining goods information included in the request, and determining position information of relevant goods using tag information corresponding to goods information among tag information already stored.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile communication system for providing goods information according to an exemplary embodiment of the present invention;

FIG. 2 is a block diagram illustrating an information collector for providing goods information according to an exemplary embodiment of the present invention;

FIG. 3 is a flowchart illustrating a process for recognizing goods information in a mobile terminal according to an exemplary embodiment of the present invention; and

FIG. 4 is a flowchart illustrating a process for providing, at an information collector, position information for each goods according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for giving an aid to a user's purchase activity by providing position information of goods using tag information recorded on a Radio Frequency IDentification (RFID) tag and information of an RFID reader that recognizes the tag information in a mobile terminal.

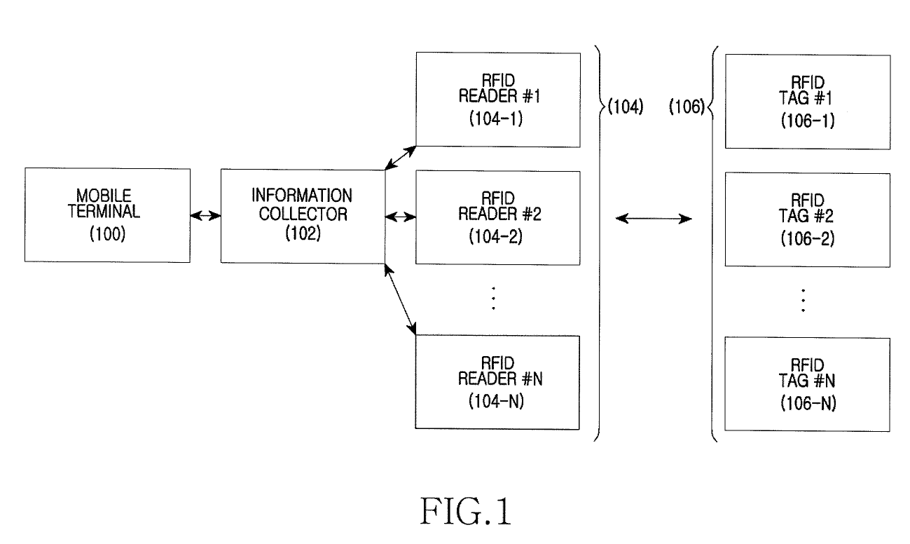

FIG. 1 is a block diagram illustrating a mobile communication system for providing goods information according to an exemplary embodiment of the present invention.

Referring to FIG. 1, the mobile communication system may include a mobile terminal 100, an information collector 102, an RFID reader 104, and an RFID tag 106. The RFID reader 104 may include a plurality of readers 104-1, 104-2, . . . , 104-n, and the RFID tag 106 may include a plurality of tags 106-1, 106-2, . . . , 106-n.

First, the mobile terminal 100 of the mobile communication system transmits a goods' name for determining a position search to the information collector 102 in order to determine goods information, and receives and outputs position information of relevant goods provided by the information collector 102.

The information collector 102 that has received a goods information request from the mobile terminal 100 controls the plurality of RFID readers 104-1, 104-2, . . . , 104-n to receive tag information from the plurality of RFID tags 106-1, 106-2, . . . , 106-n.

The information collector 102 that has received the tag information stores the received tag information, and determines a position of goods requested by the mobile terminal 100 using tag information corresponding to the goods requested by the mobile terminal 100 to transmit the same to the mobile terminal 100. The information collector 102 may determine position information of the goods using position information of the RFID reader 104 that has recognized tag information of the goods for position determination.

The RFID readers 104-1, 104-2, . . . , and 104-n receive tag information from the plurality of RFID tags 106-1, 106-2, . . . , and 106-n under control of the information collector. The RFID tags 106-1, 106-2, . . . , and 106-n transmit the tag information to the RFID readers 104-1, 104-2, . . . , and 104-n.

The RFID readers 104-1, 104-2, . . . , and 104-n doubly receive tag information corresponding to a plurality of goods to provide the same to the information collector 102. The information collector 102 may determine a position of relevant goods using positions of the RFID readers 104-1, 104-2, . . . , and 104-n that have received tag information of the relevant goods. For example, the information collector 102 may determine the position of the relevant goods by applying a triangulation method to positions of the RFID readers 104-1, 104-2, . . . , and 104-n that have received the tag information.

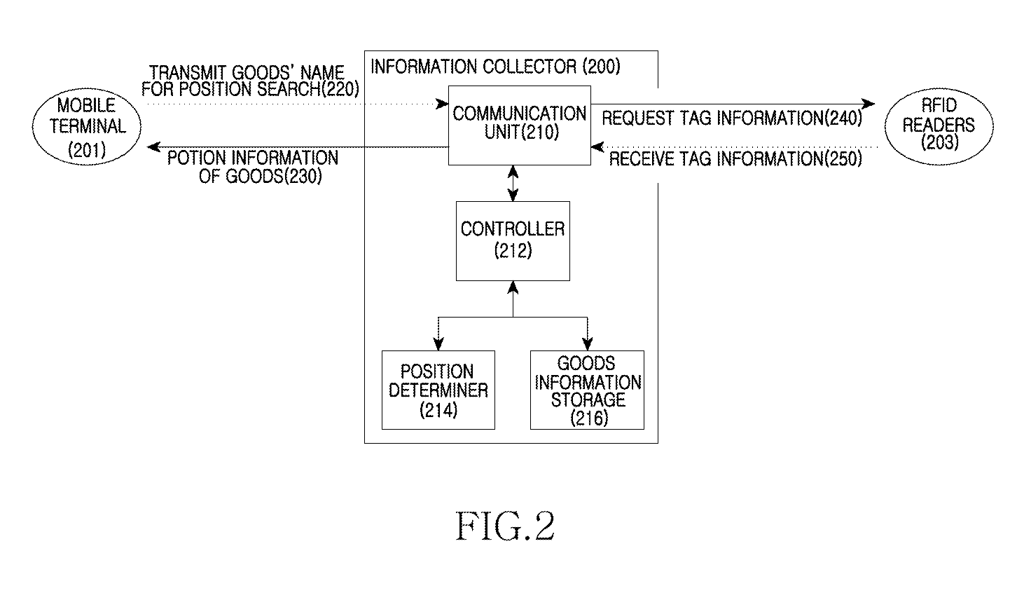

FIG. 2 is a block diagram illustrating an information collector for providing goods information according to an exemplary embodiment of the present invention.

Referring to FIG. 2, the information collector 200 may include a communication unit 210, a controller 212, a position determiner 214, and a goods information storage 216. A portable terminal may include additional units. Similarly, the functionality of two or more of the above units may be integrated into a single component.

First, the controller 212 of the information collector 200 controls an overall operation of the information collector 200. The operation of the controller 212 is described in more detail below. The controller 212 communicates with RFID readers 203 to receive and store tag information collected by the RFID readers 203. The controller 212 stores the received tag information in the goods information storage 216.

Thereafter, when receiving a goods information request from a mobile terminal 201, the controller 212 determines information of goods whose position is requested by the mobile terminal 201 among tag information already stored to obtain tag information corresponding to relevant goods. The controller 212 determines RFID readers 203 that have recognized the determined tag information, and then may determine position information of the goods using position information of the RFID readers 203. The tag information corresponding to the relevant goods is tag information already stored by the information collector 200, and may include information of the RFID reader 203 that has recognized the tag information.

The controller 212 may determine the position information of the goods using the position determiner 214.

The position determiner 214 determines the position of the relevant goods using the positions of the RFID readers 203 that have recognized the tag information under control of the controller 212. The goods information storage 216 stores tag information received from the RFID readers 203.

The position determiner 214 may determine the position of the relevant goods using a trilateration method such as a Time of Arrival (ToA) method using a signal transmission time between the RFID reader 203 and the RFID tag, a Time Difference of Arrival (TDoA) method using a difference in a distance between the RFID reader 203 and the RFID tag, and a method that estimates a point where an antenna direction (i.e., coverage) of the RFID reader 203 and a signal source meet as the position of the relevant goods.

The communication unit 210 communicates with the mobile terminal 201 and the RFID readers 203. That is, the communication unit 210 receives a position information request including a goods' name whose position is to be searched for from the mobile terminal 201 in step 220, and transmits information corresponding to the position information request, that is, position information of the goods corresponding to the goods' name to the mobile terminal 201 in step 230.

Additionally, the communication unit 210 transmits a tag information request, which is a command for controlling operations of the RFID readers 203, in step 240, and receives tag information from the RFID readers 203 in step 250.

The function of the position determiner 214 may be performed by the controller 212 of the information collector 200. Separate configuration and illustration of the position determiner 214 are for exemplary purpose only and for convenience in description, and is not limiting to the scope of the present invention. It would be obvious to those skilled in the art that various modifications may be made within the scope of the present invention. For example, all of the functions of the position determiner 214 may be processed by the controller 212.

An exemplary apparatus for giving an aid to a user's purchase activity by providing tag information recorded on an RFID tag and position information of goods using information of an RFID reader that has recognized the tag information in a mobile terminal has been described above. An exemplary method for providing a goods information service that provides position information of goods using tag information recorded on an RFID tag and information of an RFID reader that has recognized the tag information using the above-described apparatus is described below.

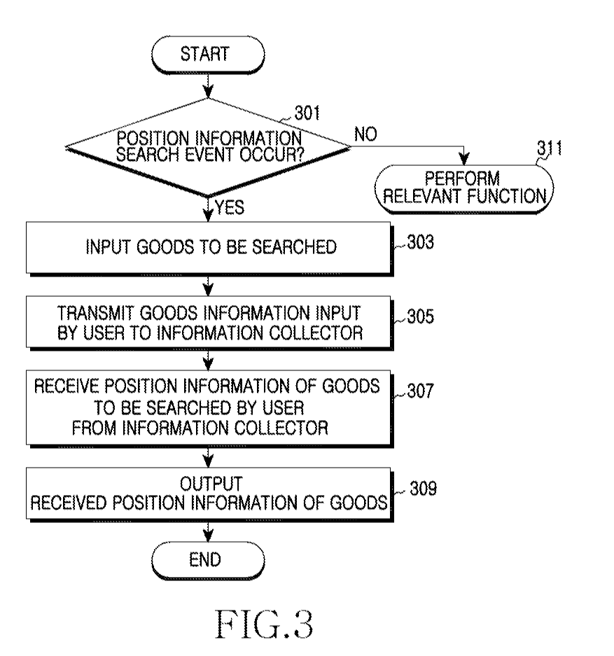

FIG. 3 is a flowchart illustrating a process for recognizing goods information in a mobile terminal according to an exemplary embodiment of the present invention.

Referring to FIG. 3, the mobile terminal determines whether a position information search event occurs in step 301. The position information search event denotes an event that intends to determine a position of goods a user of the mobile terminal desires to purchase.

If it is determined that the position information search event does not occur in step 301, the mobile terminal performs a relevant function (e.g., a standby mode) in step 311.

In contrast, if it is determined that the position information search event occurs in step 301, the mobile terminal outputs a separate screen on which a name of goods a user intends to search for is to be written to allow the user to input the name of the goods whose position is to be searched for in step 303.

The mobile terminal transmits the goods information input by the user to an information collector in step 305, and then receives position information of the goods the user desires to search for from the information collector in step 307.

The mobile terminal outputs the position information received from the information collector in step 307 to provide the position of the relevant goods to the user in step 309.

Thereafter, the mobile terminal ends the process.

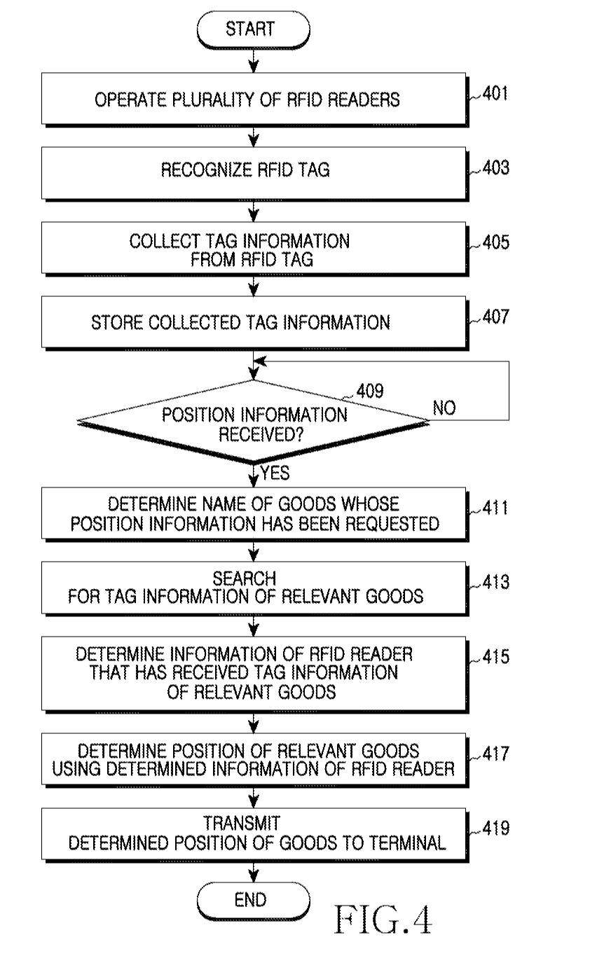

FIG. 4 is a flowchart illustrating a process for providing, at an information collector, position information for each goods according to an exemplary embodiment of the present invention.

Referring to FIG. 4, the mobile terminal allows a plurality of RFID readers to operate in step 401, and recognizes an RFID tag in step 403.

The mobile terminal collects tag information from the recognized RFID tag in step 405. At this point, an RFID reader controlled by the information collector includes a plurality of RFID readers to doubly receive tag information corresponding to a plurality of goods. By using positions of RFID readers that have received tag information of the goods, the position of goods may be determined.

The information collector stores tag information, which is collected in step 405, in step 407, and determines whether a position information request is received from the mobile terminal in step 409. The position information request denotes that the mobile terminal requests a position of specific goods. The mobile terminal may request position information by transmitting goods' name to be searched for to the information collector.

If it is determined that the position information request is not received in step 409, the information collector determines again whether a position information request is received from the mobile terminal in step 409.

In contrast, if it is determined that the position information request is received in step 409, the information collector determines goods' name included in the position information request, that is, the name of the goods whose position information has been requested in step 411, and searches for tag information of the relevant goods, that is, the goods whose position information has been requested among tag information, which is stored in step 407, in step 413.

The information collector determines information of RFID readers that have received (i.e., detected) the tag information, which is searched in step 413, in step 415, and determines the position of relevant goods using the determined information (i.e., position information) of the RFID readers in step 417. That is, the information collector may determine the position of the relevant goods using distances between the RFID tag and the RFID readers.

The information collector may determine the position of the relevant goods using a trilateration method such as a ToA method for determining the position of relevant goods by measuring signal transmission times between RFID readers that receive tag information of the relevant goods and the tag of the relevant goods, a TDoA method for determining the position of the relevant goods by determining intersections of hyperbolic curves using a fact that differences in a distance between the RFID readers and the tag form hyperbolic curves, and a method of disposing a plurality of antennas provided to one RFID reader in respective directions, receiving a number of an antenna that transmits a signal, and estimating a point where antenna directions (i.e., coverage) of the respective antennas and a signal source meet as the position of the relevant goods.

As described above, the information collector that determined the position of the relevant goods transmits the position of the relevant good to the mobile terminal in step 419, and ends the process.

As described above, an exemplary embodiment of the present invention determines the position of relevant goods using tag information of an RFID tag and information (i.e., position information) of an RFID reader that has recognized the tag information, and provides the determined position of the relevant goods to a user of a mobile terminal, so that goods located at a distance far away may be searched. Therefore, when the user purchases goods, a time used for searching for the relevant goods may be reduced and the user may purchase the goods efficiently.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing goods information at an information collector, the apparatus comprising:
a goods information storage for receiving and storing tag information collected by a Radio Frequency IDentification (RFID) reader;
a position determiner for determining position information of relevant goods using tag information corresponding to goods information among tag information already stored; and
a controller for, when receiving a position information request, processing to determine goods information included in the request and determine the position information of the relevant goods.

2. The apparatus of claim 1, further comprising:
a communication unit for transmitting the determined position information of the relevant goods to a mobile terminal.

3. The apparatus of claim 2, wherein the communication unit transmits a tag information request to the RFID reader and receives tag information from the RFID reader.

4. The apparatus of claim 1, wherein the position determiner determines the position information of the relevant goods using a distance between the RFID reader and an RFID tag that provides the tag information.

5. The apparatus of claim 4, wherein the position determiner determines position information of the RFID reader that has recognized tag information using the tag information corresponding to the goods information included in the request, and determines the position information of the relevant goods using the position information of the RFID reader.

6. The apparatus of claim 5, wherein the position determiner determines the position information of the relevant goods using at least one of a Time of Arrival (ToA) method using a signal transmission time between the RFID reader and the RFID tag, a Time Difference of Arrival (TDoA) method using a difference in a distance that is a signal delivery time difference between the RFID reader and the RFID tag, and a method that estimates a point where an antenna direction that is a coverage area of RFID readers and a signal source meet as a position of the relevant goods.

7. The apparatus of claim 6, wherein the mobile terminal outputs the position information received from the information collector comprising the position of the relevant goods.

8. The apparatus of claim 1, wherein the RFID reader that collects the tag information comprises a plurality of RFID readers to doubly receive tag information corresponding to a plurality of goods.

9. A method for providing goods information at an information collector, the method comprising:
receiving and storing tag information collected by a Radio Frequency IDentification (RFID) reader;
when receiving a position information request, determining goods information included in the request; and
determining position information of relevant goods using tag information corresponding to goods information among tag information already stored.

10. The method of claim 9, further comprising:
transmitting the determined position information to a mobile terminal.

11. The method of claim 9, wherein the determining of the position information of the relevant goods comprises using a distance between the RFID reader and an RFID tag that provides the tag information.

12. The method of claim 11, wherein the determining of the position information of the relevant goods further comprises:
obtaining the tag information corresponding to the goods included in the request;
determining position information of the RFID reader that has recognized the tag information using the obtained tag information; and
determining the position information of the relevant goods using the position information of the RFID reader.

13. The method of claim 12, wherein the determining of the position information of the relevant goods further comprises using at least one of a Time of Arrival (ToA) method using a signal transmission time between the RFID reader and the RFID tag, a Time Difference of Arrival (TDoA) method using a difference in a distance that is a signal delivery time difference between the RFID reader and the RFID tag, and a method that estimates a point where an antenna direction that is a coverage area of RFID readers and a signal source meet as a position of the relevant goods.

14. The method of claim 13, wherein the mobile terminal outputs the position information received from the information collector comprising the position of the relevant goods.

15. The method of claim 9, wherein the RFID reader that collects the tag information comprises a plurality of RFID readers to doubly receive tag information corresponding to a plurality of goods.
